(19) United States
(12) Patent Application Publication
(10) Pub. No.: US 2025/0004699 A1
(43) Pub. Date: Jan. 2, 2025

(54) UTTERANCE DESIRE ESTIMATION APPARATUS, UTTERANCE DESIRE ESTIMATION METHOD, AND PROGRAM

(71) Applicant: NIPPON TELEGRAPH AND TELEPHONE CORPORATION, Tokyo (JP)

(72) Inventors: Shunichi SEKO, Tokyo (JP); Naoki HAGIYAMA, Tokyo (JP); Mana SASAGAWA, Tokyo (JP); Rika MOCHIZUKI, Tokyo (JP); Harumi SAITO, Tokyo (JP); Ryuji YAMAMOTO, Tokyo (JP)

(73) Assignee: NIPPON TELEGRAPH AND TELEPHONE CORPORATION, Tokyo (JP)

(21) Appl. No.: 18/700,707

(22) PCT Filed: Nov. 16, 2021
(86) PCT No.: PCT/JP2021/042076

§ 371 Date: Apr. 12, 2024

(51) Int. Cl. G06F 3/16

(52) U.S. Cl. CPC G06F 3/165

(57) ABSTRACT

A speech desire estimation device according to one aspect of the present invention is provided in a first conference device among a plurality of conference devices used for a remote conference via a communication network, and the speech desire estimation device includes an operation information generation unit that generates operation information indicating an operation performed by a user on the first conference device during the remote conference, a speech desire degree calculation unit that calculates a speech desire degree indicating a degree of desire of the user to speak on the basis of the generated operation information, and a communication unit that transmits information based on the calculated speech desire degree to a second conference device among the plurality of conference devices.

### TECHNICAL FIELD

The present invention relates to a technique for estimating a user's desire to speak in a remote conference.

### BACKGROUND ART

In a remote conference such as a web conference, it is difficult to ascertain a person who wants to speak (a person who desires to speak) in comparison with real face-to-face communication due to the effects of blurred videos and network delays.

PTL 1 discloses a technique for acquiring the behavior of a user (participant in a remote conference) from a camera and a microphone, and calculating and displaying the degree of the user's desire to speak. According to the technique, each user can easily ascertain who wants to speak.

However, in remote conferences, turning off cameras or microphones is often performed to prevent communication interference due to line pressure or noise, and there is a problem that it is difficult to estimate the desire to speak using video and audio.

### CITATION LIST

### Patent Literature

[PTL 1] Japanese Patent Application Publication No. 2013-183183

### SUMMARY OF INVENTION

### Technical Problem

An object of the present invention is to provide a technique for estimating a user's desire to speak without using video and audio information.

### Solution to Problem

According to one aspect of the present invention, there is provided a speech desire estimation device provided in a first conference device among a plurality of conference devices used for a remote conference via a communication network, the speech desire estimation device including: an operation information generation unit configured to generate operation information indicating an operation performed by a user on the first conference device during the remote conference; a speech desire degree calculation unit configured to calculate a speech desire degree indicating a degree of desire of the user to speak on the basis of the generated operation information; and a communication unit configured to transmit information based on the calculated speech desire degree to a second conference device among the plurality of conference devices.

### Advantageous Effects of Invention

According to the present invention, there is provided a technique for estimating a user's desire to speak without using video and audio information.

### BRIEF DESCRIPTION OF DRAWINGS

FIG. 1 is a block diagram illustrating a conference system according to an embodiment.

FIG. 2 is a functional block diagram illustrating a client provided with a speech desire estimation device according to the embodiment.

FIG. 3 is a diagram illustrating a user interface of a remote conference application according to the embodiment.

FIG. 4 is a diagram illustrating operation information stored in an operation information storage unit illustrated in FIG. 2.

FIG. 5 is a block diagram illustrating a hardware configuration of the client provided with the speech desire estimation device according to the embodiment.

FIG. 6 is a flowchart illustrating a speech desire estimation method according to the embodiment.

FIG. 7 is a functional block diagram illustrating a client provided with a speech desire estimation device according to the embodiment.

### DESCRIPTION OF EMBODIMENTS

Embodiments of the present invention will be described below with reference to the drawings.

Embodiments relate to a conference system in which a plurality of users present at different locations perform a remote conference using a plurality of conference devices connected to a communication network. In one embodiment, each conference device includes a speech desire estimation device for estimating a user's desire to speak using the conference device. The speech desire estimation device calculates the speech desire degree of the user on the basis of an operation performed by the user to the conference device during the remote conference, and transmits information based on the calculated speech desire degree to another conference device. The speech desire degree indicates a degree (level) of desire of the user to speak. Each conference device receives information indicating the speech desire degree of another user from another conference device, and presents the received information to the user. With the conference system according to the embodiment, it is possible to estimate the speech desire of each user without using video and audio information, and each user can easily determine whether or not another user desires speech. As a result, it is possible to avoid collision of speech.

### First Embodiment

### [Configuration]

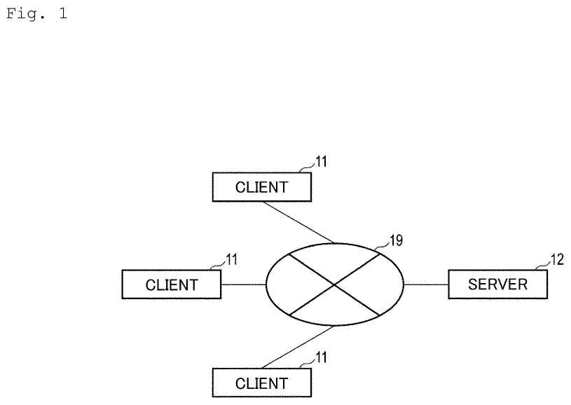

FIG. 1 schematically illustrates a conference system 10 according to a first embodiment. As illustrated in FIG. 1, the conference system 10 includes a plurality of clients 11 used by a plurality of users, respectively, and a server 12 connected to the clients 11 via a communication network 19. The communication network 19 may include the Internet, an intranet, or a combination of the Internet and the intranet. The server 12 relays data between the clients 11. For example, the server 12 receives data from the client 11 via the communication network 19 and transfers the received data to another client 11 via the communication network 19.

Each client 11 may be a computer such as a personal computer (PC). The client 11 corresponds to a conference device used for a remote conference via the communication network 19. In the present embodiment, the client 11 functions as a conference device by executing a remote conference application. In other embodiments, the client 11 may function as a conference device by accessing the server 12 using a browser.

The clients 11 can have the same or similar configurations as each other. In the following, the configuration of one client 11 will be described as a representative.

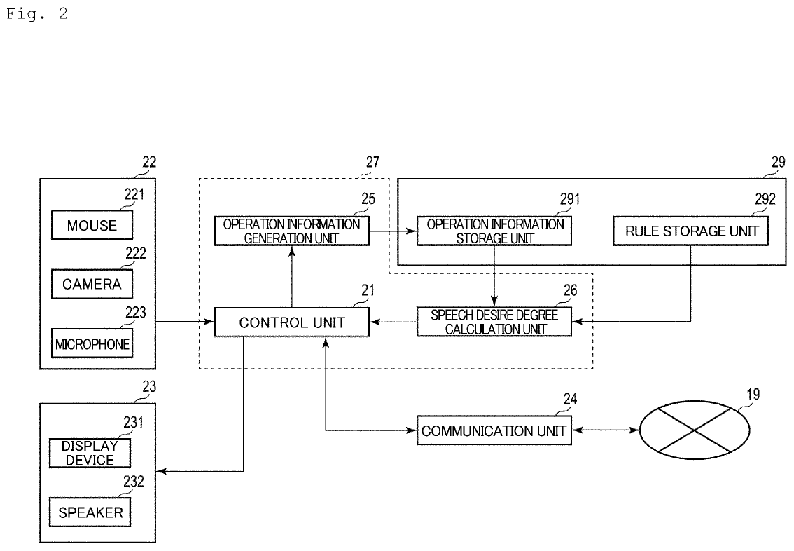

FIG. 2 schematically illustrates the functional configuration of the client 11 according to the present embodiment. As illustrated in FIG. 2, the client 11 includes a control unit 21, an input unit 22, an output unit 23, a communication unit 24, an operation information generation unit 25, a speech desire degree calculation unit 26, and a storage unit 29. The storage unit 29 includes an operation information storage unit 291 and a rule storage unit 292. The control unit 21, the operation information generation unit 25, and the speech desire degree calculation unit 26 are collectively referred to as a processing unit 27. The control unit 21, the communication unit 24, the operation information generation unit 25, the speech desire degree calculation unit 26, the operation information storage unit 291, and the rule storage unit 292 correspond to a speech desire estimation device according to the present embodiment.

The control unit 21 controls the operation of the client 11. Specifically, the control unit 21 controls the input unit 22, the output unit 23, the communication unit 24, the operation information generation unit 25, the speech desire degree calculation unit 26, and the storage unit 29.

The input unit 22 receives an input from the user and sends the received input to the control unit 21. In the example illustrated in FIG. 2, the input unit 22 includes a mouse 221, a camera 222, and a microphone 223. The mouse 221 allows the user to operate the client 11. For example, the mouse 221 allows a user to operate a user interface provided by a remote conference application. Instead of or in addition to the mouse 221, a touch pad (track pad), a touch panel, a keyboard, or the like may be used. The camera 222 images a user and generates video data indicating a video of the user. The camera 222 may include a physical button for switching the camera 222 between on and off. The microphone 223 collects vocal sound uttered by the user and generates voice data indicating the vocal sound of the user. The microphone 223 may include a physical button for switching the microphone 223 between on and off. The control unit 21 receives the video data from the camera 222 and the voice data from the microphone 223, and transmits the video data and the voice data to the other client 11 via the communication unit 24.

The output unit 23 outputs information generated by the control unit 21 to the user. In the example illustrated in FIG. 2, the output unit 23 includes a display device 231 and a speaker 232. The display device 231 is a display such as a liquid crystal display device, and displays an image generated by the control unit 21. For example, the control unit 21 generates an image including a user interface provided by a remote conference application, and the display device 231 displays the image including the user interface. The user interface includes an area for displaying videos of other users. The control unit 21 receives video data of another user from another client 11 via the communication unit 24, and applies the received video data to the user interface in order to display the video of the other user on the user interface. The speaker 232 emits sounds corresponding to the acoustic data supplied by the control unit 21. For example, the control unit 21 receives voice data of another user from another client 11 via the communication unit 24, and sends the received voice data to the speaker 232 so that the speaker 232 outputs the voice of the other user.

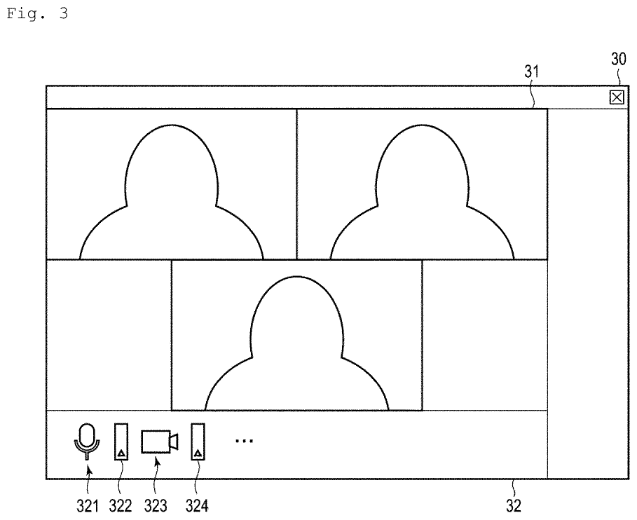

FIG. 3 schematically illustrates a user interface 30 related to a remote conference provided by a remote conference application. In the example illustrated in FIG. 3, the user interface 30 includes a video area 31 and a control bar 32. The video area 31 is an area for displaying videos of other users. The control bar 32 includes a mute button 321, an audio setting button 322, a video button 323, and a video setting button 324.

The mute button 321 is a button for switching a voice input between on (enabled) and off (disabled). When the mute button 321 is clicked while the voice input is on, the voice input is switched off, and when the mute button 321 is clicked while the voice input is off, the voice input is switched on. When the voice input is on, the voice data obtained by the microphone 223 is sent to the other client 11, and when the voice input is off, the voice data obtained by the microphone 223 is not sent to the other client 11.

The audio setting button 322 is a button for displaying an audio related list. The audio related list includes a plurality of items such as microphone setting and speaker setting. When the item of microphone setting is selected (clicked), a microphone setting screen for setting the microphone 223 is displayed. On the microphone setting screen, the volume of the microphone 223 can be adjusted.

The video button 323 is a button for switching a video input between on and off. When the video button 323 is clicked while the video input is on, the video input is switched off, and when the video button 323 is clicked while the video input is off, the video input is switched on. When the video input is on, the video data obtained by the camera 222 is transmitted to the other client 11, and when the video input is off, the video data obtained by the camera 222 is not transmitted to the other client 11.

The video setting button 324 is a button for displaying a video related list. The video related list includes a plurality of items such as camera switching and camera setting. When the item of camera setting is selected, a camera setting screen for setting the camera 222 in use is displayed. On the camera setting screen, a video obtained by the camera 222 in use is displayed.

Referring back to FIG. 2, the communication unit 24 communicates with another client 11 via the communication network 19 and the server 12. The communication unit 24 transmits information related to the remote conference received from the control unit 21 to other clients 11. For example, the communication unit 24 transmits video data obtained by the camera 222 and voice data obtained by the microphone 223 to other clients 11. The communication unit 24 receives information related to the remote conference from another client 11, and sends the received information to the control unit 21. For example, the communication unit 24 receives video data and voice data obtained by another client 11 from the other client 11.

The operation information generation unit 25 generates operation information indicating the operation of the client 11 performed by the user during the remote conference, and causes the operation information storage unit 291 to store the generated operation information. The operation information includes information indicating an operation performed by the user to the client 11 during the remote conference, specifically, information indicating an operation performed by the user to a user interface provided by the remote conference application during the remote conference. Examples of operations to be recorded include cursor placement on the mute button 321, switching of a voice input from off to on, display of a microphone setting screen, display of a speaker setting screen, display of a camera setting screen, transition of a remote conference application to a foreground, transition of the remote conference application to a background, speech, and the like. A state in which the remote conference application is operating in the foreground refers to an active state in which a user can operate the remote conference application. A state in which the remote conference application is operating in the background refers to a state in which the remote conference application is operating but the user cannot operate the remote conference application. The operation information generation unit 25 receives mouse operation information indicating an operation of the mouse 221 performed by the user and screen information indicating an image to be displayed on the display device 231 from the control unit 21. The operation information generation unit 25 can detect an operation to the user interface from the operation information and the screen information. For example, the operation information generation unit 25 can detect the position of the cursor on the user interface from the operation information and the screen information. For example, the operation information generation unit 25 detects that the cursor moves onto the mute button 321 and stays on the mute button 321, and generates operation information related to an operation of cursor placement onto the mute button 321.

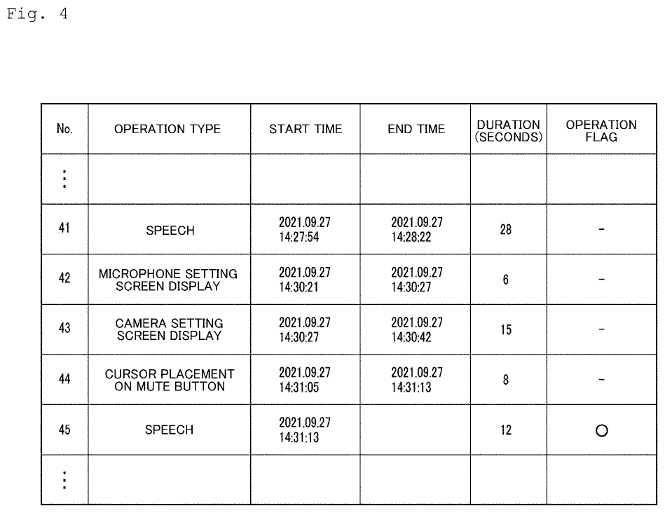

FIG. 4 schematically illustrates an example of the operation information stored in the operation information storage unit 291. Each operation is managed by one record (entry). In the example illustrated in FIG. 4, each record includes an identifier (No.), operation type, start time, end time, duration, and operation flag as data items. The identifier indicates information for identifying the operation. For example, the identifier indicates the order in which the operations were performed. The operation type indicates the type of operation. The start time indicates the time when the operation was started. The end time indicates the time when the operation ended. The duration indicates the length of time when the operation was performed. The operation flag indicates whether or not the operation is continuing. An operation flag “-” indicates that the operation has ended, and an operation flag “∘” indicates that the operation is continuing.

Referring back to FIG. 2, the speech desire degree calculation unit 26 calculates the speech desire degree of the user on the basis of the operation information stored in the operation information storage unit 291. In the present embodiment, a value in a range from 0 to 1 is taken, and the speech desire degree is defined so that the value increases as the degree of desire of the user to speak becomes higher.

In the present embodiment, the speech desire degree is calculated on a rule basis. The rule storage unit 292 stores a predetermined speech desire estimation rule. The speech desire degree calculation unit 26 refers to the speech desire estimation rule stored in the rule storage unit 292 in order to calculate the speech desire degree of the user. The speech desire estimation rule includes information for designating a type of operation estimated as the speech desire. Examples of the operation estimated to be the speech desire include cursor placement on the mute button, switching of a voice input from off to on, microphone setting screen display, camera setting screen display, transition of a remote conference application to a foreground, and the like.

In general, when a user speaks in a remote conference with voice input and/or video input turned off, the following behaviors are often performed.

(1) The user places the cursor over the mute button so that voice input can be switched from off to on immediately after the current speaker finishes speaking and waits for the current speaker to finish speaking.

(2) The user clicks the mute button to switch the voice input from off to on and then waits for the current speaker to finish speaking.

(3) The user displays the microphone setting screen and checks the volume of the microphone.

(4) The user displays the camera setting screen and checks the video shown on the camera.

(5) The user brings the remote conference application back to the foreground.

Behaviors that are often performed before speech as described above (pre-behaviors of the speech) are employed as operations that are estimated to be speech desires. In the following, the operation estimated to be the speech desire is also referred to as a target operation. The cursor placement on the mute button, the microphone setting screen display, and the camera setting screen display are continuous target operations, and the switching of a voice input from off to on and the transition of the remote conference application to the foreground are instantaneous target operations. The speech desire degree calculation unit 26 estimates that the user is in a speech desire state when an operation matching the target operation occurs after a user's last speech (when the user does not speak yet, at the time of participating in the remote conference or at the time of starting the remote conference).

The speech desire degree calculation unit 26 calculates a score indicating a likelihood that the operation is a pre-behavior of the speech for each of the operations performed by the user after the last speech, and calculates the speech desire degree on the basis of the calculated score. The speech desire estimation rule may include a reference time set for each of the continuous target operations. The reference time of each target operation is used to calculate the score of the operation. As an example, the reference time related to the cursor placement on the mute button is set to 5 seconds, the reference time related to the microphone setting screen display is set to 5 seconds, and the reference time related to the camera setting screen display is set to 10 seconds.

When the operation is a continuous target operation such as cursor placement on the mute button, the speech desire degree calculation unit 26 calculates a score of the operation from the duration of the operation and a reference time related to the target operation. For example, when the duration of the operation is equal to or longer than a reference time related to the target operation, the speech desire degree calculation unit 26 determines the score of the operation to be 1. When the duration of the operation is less than a reference time related to the target operation, the speech desire degree calculation unit 26 calculates a score of the operation on the basis of a difference or a ratio between the duration of the operation and the reference time related to the target operation. S=D/R, where the duration of the operation is D, the reference time related to the target operation matching the operation is R, and the score of the operation is S. In this example, when the duration D is 2 seconds and the reference time R is 5 seconds, the score S is 0.4. The score may be calculated by a function other than a linear function. For example, S=(D/R)² may be used. In this example, when the duration D is 2 seconds and the reference time R is 5 seconds, the score S is 0.16.

For example, the user may click the mute button 321 immediately after moving the cursor to the mute button 321 in order to turn on the voice input. When the user clicks the mute button 321 to turn on the voice input, the speech desire degree calculation unit 26 may determine the score of the operation of cursor placement on the mute button to be 1 regardless of the duration of cursor placement on the mute button.

When the operation is an instantaneous target operation such as transition of a remote conference application to the foreground, the speech desire degree calculation unit 26 determines the score of the operation to be 1.

When the operation is none of the target operations, the speech desire degree calculation unit 26 determines the score of the operation to be zero.

When there is an interval of a certain period of time or more between the operations, the speech desire degree calculation unit 26 may consider that one operation (operation type “no operation”) has occurred in the period, and determine the score of the operation to be zero. The speech desire estimation rule may include information indicating the certain period of time.

The speech desire degree calculation unit 26 uses an average of scores calculated for each operation as a speech desire degree. Alternatively, the speech desire degree calculation unit 26 may obtain a load average of scores calculated for each operation as the speech desire degree. As an example, the weight related to operations that occurred from 30 seconds before the current time to the current time is set to 1, the weight related to operations that occurred from 60 seconds before the current time to 30 seconds before the current time is set to 0.9, the weight related to operations that occur from 90 seconds before the current time to 60 seconds before the current time is set to 0.8, and so on. In another example, the weight related to the operation currently performed by the user is set to 1, and the weight related to the previous operation is set to 0.9, the weight related to the two previous operations is set to 0.8, and so on.

The control unit 21 transmits user information based on the speech desire degree of the user to another client 11 via the communication unit 24. For example, the control unit 21 drives the communication unit 24 to transmit the user information to other clients 11. The user information may include the speech desire degree of the user itself. Alternatively, the user information may include information for notifying of that the user has a desire to speak. For example, the control unit 21 notifies the other client 11 that the user has a desire to speak when the speech desire degree calculated by the speech desire degree calculation unit 26 exceeds a predetermined threshold value.

The control unit 21 receives user information based on the speech desire degree of another user from another client 11 via the communication unit 24. The control unit 21 applies the received user information to a user interface. In an example in which the user information includes the speech desire degree, the control unit 21 may display the speech desire degree of each user in association with the video of each user. Alternatively, the control unit 21 may emphasize a video of a user whose speech desire degree exceeds a predetermined threshold value. For example, the control unit 21 may surround a video of a user whose speech desire degree exceeds a predetermined threshold value with a red frame, or give a mark to the video of the user whose speech desire degree exceeds the predetermined threshold value.

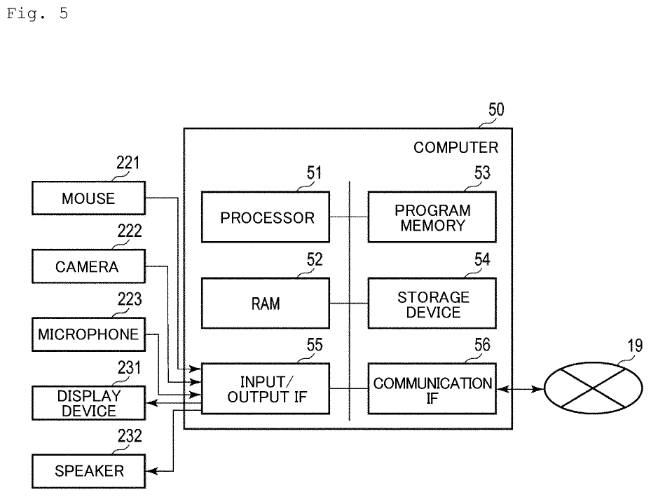

FIG. 5 schematically illustrates a hardware configuration example of the client 11. As illustrated in FIG. 5, the client 11 includes, as hardware components, a computer 50 in addition to the mouse 221, the camera 222, the microphone 223, the display device 231, and the speaker 232 illustrated in FIG. 2.

The computer 50 includes a central processing unit (CPU) 51, a random access memory (RAM) 52, a program memory 53, a storage device 54, an input/output interface 55, and a communication interface 56. The CPU 51 is communicatively connected to the RAM 52, the program memory 53, the storage device 54, the input/output interface 55, and the communication interface 56.

The CPU 51 is an example of a processor. As the processor, other general-purpose circuits may be used, and dedicated circuits such as application specific integrated circuit (ASICs) and field-programmable gate arrays (FPGAs) may be used.

The RAM 52 includes a volatile memory such as a synchronous dynamic random access memory (SDRAM). The RAM 52 is used by the CPU 51 as a working memory. The program memory 53 stores programs executed by the CPU 51 such as a remote conference application including a speech desire estimation program. The program includes computer-executable instructions. As the program memory 53, for example, a read only memory (ROM) is used. A partial area of the storage device 54 may be used as the program memory 53. The CPU 51 loads the program stored in the program memory 53 to the RAM 52, interprets and executes the program. The remote conference application, when executed by the CPU 51, causes the CPU 51 to perform a series of processes described with respect to the processing unit 27. In other words, the CPU 51 functions as the control unit 21, the operation information generation unit 25, and the speech desire degree calculation unit 26 according to the remote conference application. The speech desire estimation program may be provided as a program separate from the remote conference application. The speech desire estimation program, when executed by the CPU 51, causes the CPU 51 to perform a series of processes related to the speech desire estimation.

The program may be provided to the computer 50 while being stored in a computer-readable recording medium. In this case, the computer 50 includes a drive for reading data from the recording medium and acquires the program from the recording medium. Examples of the recording medium include a magnetic disk, an optical disc (CD-ROM, CD-R, DVD-ROM, DVD-R, or the like), a magneto-optical disk (MO or the like), and a semiconductor memory. Further, the program may also be distributed through a network. Specifically, the program may be stored in a server on a network, and the computer 50 may download the program from the server.

The storage device 54 includes a non-volatile memory such as a hard disk drive (HDD) or a solid state drive (SSD). The storage device 54 stores data. The storage device 54 functions as the storage unit 29, specifically, the operation information storage unit 291 and the rule storage unit 292.

The input/output interface 55 is an interface for communicating peripheral devices. The mouse 221, the camera 222, the microphone 223, the display device 231, and the speaker 232 are connected to the computer 50 through the input/output interface 55. In an example in which the computer 50 is a laptop PC, the camera 222, the microphone 223, the display device 231, and the speaker 232 may be built into the computer 50.

The communication interface 56 is an interface for communicating with external devices (for example, the server 12 and other clients 11 illustrated in FIG. 1) connected to the communication network 19. The communication interface 56 includes a wired module and/or a wireless module. The communication interface 56 functions as the communication unit 24.

### [Operations]

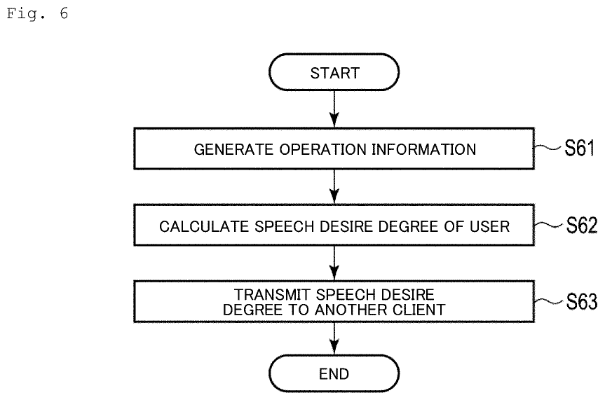

FIG. 6 schematically illustrates a speech desire estimation method executed by the client 11 illustrated in FIG. 2. Here, it is assumed that another user is speaking at the current time.

In step S61 of FIG. 6, the operation information generation unit 25 generates operation information indicating an operation performed by the user on the client 11 during the remote conference, and causes the operation information storage unit 291 to store the generated operation information. Specifically, the operation information generation unit 25 generates operation information indicating an operation of the user on the user interface provided by a conference application.

In step S62, the speech desire degree calculation unit 26 calculates a speech desire degree of the user on the basis of the operation information. For example, the speech desire degree calculation unit 26 specifies an operation performed by the user on the client 11 after previous speech by the user during the remote conference from the operation information stored in the operation information storage unit 291, calculates a score for each operation, and calculates a speech desire degree from the calculated score. When the operation is any of the target operations, the speech desire degree calculation unit 26 calculates a score of the operation on the basis of the duration D of the operation and the reference time R related to the target operation. The speech desire degree calculation unit 26 determines the score to be 1 when the duration D of the operation is equal to or longer than the reference time R related to the target operation, and obtains a value obtained by dividing the duration D of the operation by the reference time R related to the target operation type as the score of the operation when the duration D of the operation is less than the reference time R related to the target operation type. When the operation is none of the target operations, the speech desire degree calculation unit 26 determines the score of the operation to be zero. When there is an interval of a certain period of time between the operations, the speech desire degree calculation unit 26 considers that an operation that does not correspond to the target operation has been performed, and determines the score of the operation to be zero. Subsequently, the speech desire degree calculation unit 26 averages the scores calculated for each detected operation to obtain the speech desire degree of the user.

In step S63, the control unit 21 transmits user information including the speech desire degree of the user obtained in step S62 to another client 11 via the communication unit 24.

The process shown in step S61 may be executed periodically, for example, at intervals of one second during the remote conference. The processes shown in steps S62 and S63 may be executed periodically, for example, at intervals of one second during the remote conference and while the user is not speaking.

Calculation of the speech desire degree will be described with reference to the operation information illustrated in FIG. 4. Here, it is assumed that the reference time related to the cursor placement on the mute button is set to 5 seconds, the reference time related to the microphone setting screen display is set to 5 seconds, and the reference time related to the camera setting screen display is set to 10 seconds.

From 14:28:22 to 14:30:21 when the speech is finished, the user does not perform any operation and the speech desire degree is zero. Since no operation occurred for 60 seconds at 14:29:22, the speech desire degree calculation unit 26 determines that one operation has occurred, and determines the score of the operation to be zero. The speech desire degree remains zero.

At 14:30:21, the user opens the microphone setting screen. At 14:30:22, the score of the microphone setting screen display is 0.2 (=1/5), and the speech desire degree is 0.1 (=(0+0.2)/2)). The speech desire degree S is 0.2 at 14:30:23, 0.3 at 14:30:24, 0.4 at 14:30:25, and 0.5 from 14:30:26 to 14:30:27.

At 14:30:27, the user closes the microphone setting screen and opens the camera setting screen. At 14:30:27, the score of the camera setting screen display is 0.1 (=1/10), and the speech desire degree is 0.37 (≈(0+1+0.1)/3). The speech desire degree is 0.4 at 14:30:27, 0.43 at 14:30:28, . . . , 0.63 at 14:30:36, and 0.67 from 14:30:37 to 14:31:05. At 14:30:42, the user closes the camera setting screen and does not operate from 14:30:42 to 14:31:05.

At 14:31:05, the user operates the mouse 221 to align the cursor with the mute button 321. At 14:31:06, the score for placing the cursor on the mute button is 0.2 (=1/5), and the speech desire degree is 0.55 (≈(0+1+1+0.2)/4). The speech desire degree is 0.6 at 14:31:07, 0.65 at 14:31:08, 0.7 at 14:31:09, and 0.75 from 14:31:10 to 14:31:13. At 14:31:13, the user clicks the mute button 321 to start speaking.

### Effects

In the present embodiment, each of the clients 11 used in the remote conference via the communication network 19 generates operation information indicating an operation performed by the user on the client 11 during the remote conference, calculates a speech desire degree of the user on the basis of the operation information, and transmits the calculated speech desire degree to the other clients 11. Operation information indicating an operation performed by the user on the client 11 is used to calculate the speech desire degree. According to the configuration, it is possible to estimate a user's desire to speak without using voice and video information. Further, other clients 11 are notified of the calculated speech desire degree. According to the configuration, the speech desire degree of another user can be displayed in each client 11. As a result, the user of each client 11 can determine whether or not the other user desires the speech, thereby avoiding collision of speech.

The client 11 specifies an operation performed by the user on the client 11 after previous speech by the user during the remote conference from the operation information, calculates a score indicating a likelihood that the operation is a pre-behavior of the speech for each specified operation, and calculates a speech desire degree from the calculated score. According to the configuration, it is possible to evaluate whether or not the user has performed the pre-behavior of the speech, and to appropriately estimate the user's desire to speak.

When the operation is a continuous target operation, the client 11 may calculate the score of the operation on the basis of comparison between the duration of the operation and the reference time related to the target operation. According to the configuration, it is possible to calculate the score according to the length of time during which the operation is performed.

The continuous target operation may include at least one of placing a cursor on a mute button for switching a voice input between on and off, displaying a microphone setting screen for setting a microphone, and displaying a camera setting screen for setting a camera. These are typical examples of the pre-behavior of the speech, and therefore, the user's desire to speak can be appropriately estimated.

### Second Embodiment

In the first embodiment described above, the speech desire degree is calculated on a rule basis. In a second embodiment, a speech desire degree is calculated using a speech desire estimation model obtained by machine learning. In the second embodiment, descriptions of the same components and processing as in the first embodiment will be omitted as appropriate.

### [Configuration]

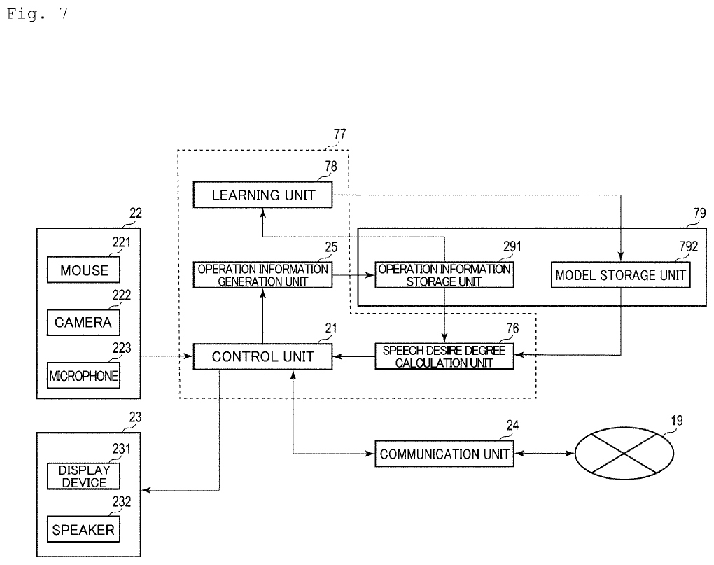

FIG. 7 schematically illustrates a client 71 according to the second embodiment. The conference system according to the second embodiment is the same as that illustrated in FIG. 1, and the client 71 illustrated in FIG. 7 is used as a substitute for the client 11 illustrated in FIG. 1. In FIG. 7, the same reference numerals are given to the same components as those illustrated in FIG. 2, and the description thereof will be omitted as appropriate.

As illustrated in FIG. 7, the client 71 includes a control unit 21, an input unit 22, an output unit 23, a communication unit 24, an operation information generation unit 25, a speech desire degree calculation unit 76, a learning unit 78, and a storage unit 79. The storage unit 79 includes an operation information storage unit 291 and a model storage unit 792. The control unit 21, the operation information generation unit 25, the speech desire degree calculation unit 76, and the learning unit 78 are collectively referred to as a processing unit 77. The control unit 21, the communication unit 24, the operation information generation unit 25, the speech desire degree calculation unit 76, the learning unit 78, the operation information storage unit 291, and the model storage unit 792 correspond to a speech desire estimation device according to the second embodiment.

The learning unit 78 generates a speech desire estimation model configured to receive, as an input, operation information indicating at least one operation on the client 71 by machine learning and output a numerical value representing a speech desire degree. The learning unit 78 learns the speech desire estimation model using the operation information stored in the operation information storage unit 291 as learning data. The speech desire estimation model may be a neural network, and learning is processing for determining parameters (weight and bias) constituting the neural network.

The learning unit 78 generates operation information leading to speech and operation information not leading to speech from the operation information stored in the operation information storage unit 291. For example, the learning unit 78 obtains operation information in a predetermined period (for example, 60 seconds) immediately before each speech as the operation information leading to speech. Specifically, the learning unit 78 obtains operation information from a time 60 seconds before the start time of each speech to the start time of the speech as the operation information leading to speech. The learning unit 78 obtains operation information in a predetermined period (for example, 60 seconds) before it as the operation information not leading to speech. Specifically, the learning unit 78 obtains operation information from a time 120 seconds before the start time of each speech to a time 60 seconds before the start time of the speech, operation information from a time 180 seconds before the start time of each speech to a time 120 seconds before the start time of the speech, and the like, as the operation information not leading to speech.

The learning unit 78 performs machine learning of the speech desire estimation model using operation information leading to speech and operation information not leading to speech as inputs to the speech desire estimation model. The model storage unit 792 stores the speech desire estimation model generated by the learning unit 78.

The speech desire degree calculation unit 76 calculates the speech desire degree of the user on the basis of the operation information stored in the operation information storage unit 291 using the speech desire estimation model. For example, the speech desire degree calculation unit 76 extracts operation information in a predetermined period (for example, 60 seconds) from the operation information stored in the operation information storage unit 291. Specifically, the speech desire degree calculation unit 76 extracts, from the operation information stored in the operation information storage unit 291, operation information indicating operations performed by the user on the client 71 from a time 60 seconds before the current time to the current time after previous speech by the user during the remote conference. The speech desire degree calculation unit 76 inputs the extracted operation information to the speech desire estimation model, and obtains a numerical value output from the speech desire estimation model as the speech desire degree.

When the range of the value output from the speech desire estimation model is not in the range of 0 to 1, the speech desire degree calculation unit 76 may perform normalization so that the value output from the speech desire estimation model is in the range of 0 to 1.

Note that the learning of the speech desire estimation model cannot be performed until the operation information is accumulated to some extent. Therefore, until the operation information is accumulated to some extent, the speech desire degree calculation unit 76 may use a speech desire estimation model prepared in advance (a speech desire estimation model preset in the remote conference application). Alternatively, the speech desire degree calculation unit 76 may calculate the speech desire degree by the same method as that described in the first embodiment.

The client 71 may have a hardware configuration similar to that illustrated in FIG. 5. The remote conference application including the speech desire estimation program according to the present embodiment, when executed by the CPU, causes the CPU to perform a series of processes described with respect to the processing unit 77. In other words, the CPU functions as the control unit 21, the communication unit 24, the operation information generation unit 25, the speech desire degree calculation unit 76, and the learning unit 78 according to the remote conference application.

### [Operations]

A learning method executed by the client 71 will be described.

The operation information generation unit 25 generates operation information indicating an operation performed by the user on the client 71 during the remote conference, and causes the operation information storage unit 291 to store the generated operation information.

The learning unit 78 generates a plurality of samples including a plurality of first samples as operation information leading to speech and a plurality of second samples as operation information not leading to speech from the operation information stored in the operation information storage unit 291. Correct data is given to each sample. For example, when the output layer of the speech desire estimation model includes two nodes, a vector (1, 0) may be given to each first sample as correct data, and a vector (0, 1) may be given to each second sample as correct data.

The learning unit 78 selects at least one sample from among the samples, for example, at random. The learning unit 78 inputs each sample to the speech desire estimation model, and obtains output data from the speech desire estimation model. The learning unit 78 updates the parameters of the speech desire estimation model so that the output data approaches the correct data. For example, a cross entropy error may be used as an objective function, and a gradient descent method may be used as an optimization algorithm.

The learning unit 78 repeatedly executes processing from sample selection to parameter update. As a result, a speech desire estimation model suitable for the user using the client 71 is generated.

Next, a speech desire estimation method executed by the client 71 will be described. Here, it is assumed that learning of the speech desire estimation model is completed. Further, it is assumed that another user is speaking at the current time.

The operation information generation unit 25 generates operation information indicating an operation performed by the user on the client 71 during the remote conference, and causes the operation information storage unit 291 to store the generated operation information.

The speech desire degree calculation unit 76 calculates the speech desire degree of the user on the basis of the operation information stored in the operation information storage unit 291 using the speech desire estimation model stored in the model storage unit 792. For example, the speech desire degree calculation unit 26 extracts operation information from a time 60 seconds before the current time to the current time from the operation information stored in the operation information storage unit 291, inputs the extracted operation information to the speech desire estimation model, and obtains a value output from the speech desire estimation model as the speech desire degree.

The control unit 21 transmits user information including the speech desire degree of the user calculated by the speech desire degree calculation unit 26 to another client 11 via the communication unit 24.

### Effects

The present embodiment can obtain the same effects as those described in the first embodiment. In the present embodiment, the speech desire degree is calculated using a speech desire estimation model obtained by machine learning. According to the configuration, it can be expected that the user's desire to speak can be estimated more appropriately.

The client 71 learns the speech desire estimation model using the operation information stored in the operation information storage unit 291 as learning data. According to the configuration, it is possible to obtain the speech desire estimation model suitable for the user, and to more appropriate estimate the user's desire to speak.

### Modification Example

In the above embodiments, the remote conference is implemented on the basis of a client server model. In other embodiments, the conference system does not include a server, and the remote conference may be performed between clients in a peer-to-peer (P2P) manner.

Note that the present invention is not limited to the embodiments described above and can variously be modified at an execution stage within a scope not departing from the gist of the present invention. In addition, the embodiments may be combined as appropriate, and in such a case, combined effects can be achieved. Furthermore, the above embodiments include various inventions, and various inventions can be extracted by a combination selected from a plurality of disclosed components. For example, even if some components are deleted from all the components described in the embodiments, in a case where the problem can be solved and the effects can be obtained, a configuration from which the components are deleted can be extracted as an invention.

### REFERENCE SIGNS LIST

10 Conference system
11 Client
12 Server
19 Communication network
21 Control unit
22 Input unit
221 Mouse
222 Camera
223 Microphone
23 Output unit
231 Display device
232 Speaker
24 Communication unit
25 Operation information generation unit
26 Calculation unit
27 Processing unit
29 Storage unit
291 Operation information storage unit
292 Rule storage unit
30 User interface
31 Video area
32 Control bar
321 Mute button
322 Audio setting button
323 Video button
324 Video setting button
50 Computer
51 CPU
52 RAM
53 Program memory
54 Storage device
55 Input/output interface
56 Communication interface
71 Client
76 Calculation unit
77 Processing unit
78 Learning unit
79 Storage unit
792 Model storage unit

1. A speech desire estimation device for use with a first conference device among a plurality of conference devices used for a remote conference via a communication network, the speech desire estimation device comprising:
operation information generation circuitry configured to generate operation information indicating an operation performed by a user on the first conference device during the remote conference:
speech desire degree calculation circuitry configured to calculate a speech desire degree indicating a degree of desire of the user to speak on the basis of the generated operation information; and
communication circuitry configured to transmit information based on the calculated speech desire degree to a second conference device among the plurality of conference devices.

2. The speech desire estimation device according to claim 1, wherein:
the speech desire degree calculation circuitry is configured to specify operations performed by the user on the first conference device after previous speech by the user during the remote conference from the generated operation information, calculate a score indicating a likelihood that the operation is a pre-behavior for speaking for each of the specified operations, and calculate the speech desire degree from the calculated score.

3. The speech desire estimation device according to claim 2, wherein:
the speech desire degree calculation circuitry is configured to, when the specified operation matches a predetermined operation, calculate the score of the specified operation on the basis of a comparison between a duration of the specified operation and a reference time set for the predetermined operation.

4. The speech desire estimation device according to claim 3, wherein;
the predetermined operation includes at least one of placing a cursor on a mute button for switching a voice input between on and off, displaying a microphone setting screen for setting a microphone, and displaying a camera setting screen for setting a camera.

5. The speech desire estimation device according to claim 1, further comprising:
a speech desire estimation model configured to receive operation information indicating at least one operation as an input and output a numerical value representing the speech desire degree,
wherein the speech desire degree calculation circuitry is configured to extract operation information indicating operations performed by the user on the first conference device after previous speech by the user during the remote conference from the generated operation information, input the extracted operation information to the speech desire estimation model, and obtain a numerical value output from the speech desire estimation model as the speech desire degree.

6. The speech desire estimation device according to claim 5, further comprising:
learning circuitry configured to learn the speech desire estimation model using the generated operation information.

7. A speech desire estimation method executed by a first conference device among a plurality of conference devices used for a remote conference via a communication network, the speech desire estimation method comprising:
generating operation information indicating an operation performed by a user on the first conference device during the remote conference;
calculating a speech desire degree indicating a degree of desire of the user to speak on the basis of the generated operation information; and
transmitting information based on the calculated speech desire degree to a second conference device among the plurality of conference devices.

8. A non-transitory computer readable medium storing a program for causing a computer to perform the method of claim 7.
